(19) United States
(12) Patent Application Publication
(10) Pub. No.: US 2006/0279115 A1
(43) Pub. Date: Dec. 14, 2006

(54) VEHICULAR HEAD AND NECK SAFETY SYSTEM AND METHOD

(76) Inventor: Ash Tisdelle, Green Cove Springs, FL (US)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 11/423,347

(22) Filed: Jun. 9, 2006

Related U.S. Application Data
(60) Provisional application No. 60/688,947, filed on Jun. 9, 2005.
(60) Provisional application No. 60/698,236, filed on Jul. 11, 2005.

(51) Int. Cl. B60N 2/42

(52) U.S. Cl. 297/216.12

(57) ABSTRACT

A vehicular head and neck safety system for use by an occupant of a vehicle comprising a net sized to contain the occupant's head while the occupant is seated in a seat of a vehicle, wherein the net is secured behind a headrest of the seat using fasteners. During a rapid deceleration event, such as a frontal collision, the system limits the forward movement and downward rotation of the occupant's head to prevent or reduce injury.

### RELATED APPLICATIONS

This application claims the benefit of priority of U.S. provisional application Ser. Nos. 60/688,947, filed Jun. 9, 2005, and 60/698,236, filed Jul. 11, 2005, which are relied on and incorporated herein by reference.

### FIELD OF THE INVENTION

The present invention relates generally to safety devices for automobile racing or for passenger automobiles. In particular, the present invention relates to a head and neck safety system for controlling and limiting the forward and downward movement of an occupant's head during rapid deceleration of the occupant's vehicle, such as in a crash.

### BACKGROUND OF THE INVENTION

During a severe frontal collision involving an automobile, a significant or fatal injury can be incurred when a properly used shoulder harness arrests the forward motion of the body but the head continues forward by inertia in an unrestricted manner, thus stretching the neck past its natural ability to restrain the head of the vehicle occupant. This can cause an injured or broken neck, brain damage, or other injuries.

Various types of devices have been proposed to prevent such injuries by limiting or otherwise controlling the motion of the head and neck of the automobile occupant. In racing cars, such devices typically involve anchoring the occupant's helmet to a point on the automobile or to a yoke, collar, or other bracing apparatus. For example, a conventional restraint device includes a number of straps that span between anchor points on the automobile chassis or seat structure and anchor points on the occupant's helmet. A problem with these devices is that attaching straps to the occupant's helmet restricts or prevents head movement during normal driving conditions and limits the occupant's peripheral vision. In addition, the use of such straps requires that the occupant's helmet be fitted with suitable anchors.

Another conventional restraint device includes a yoke held in place by the occupant's shoulder harness and a high collar that wraps around the back of the occupant's head. Various tethers are anchored to a rear portion of the yoke or to the collar and extend to connection points on the occupant's helmet. Because such devices require straps to be anchored to the occupant's helmet, those straps also restrict or prevent head movement during normal use, limit the occupant's peripheral vision, and require that the occupant's helmet be fitted with suitable anchors. Further, such devices are generally expensive and bulky. The bulkiness of these devices often requires reshaping of the automobile headrest and/or seat padding, makes it difficult for the occupant to climb in and out of the automobile, and renders the device uncomfortable to wear. Moreover, different size yokes or collars may be required for different size drivers or cockpits.

A need therefore exists for an improved vehicular head and neck safety system that overcomes the shortcomings found in the prior art.

### SUMMARY OF THE INVENTION

The present invention answers this need by providing a vehicular head and neck safety system that includes a net or open mesh fabric sized to contain the occupant's head while the occupant is seated in the seat of a vehicle. As use herein, occupant refers to the occupant of a vehicle who is using the safety system of the present invention. The net is secured behind the headrest of the seat using fasteners. During a rapid deceleration event, such as a frontal collision, the system limits the forward movement and downward rotation of the occupant's head to prevent or reduce injury.

Generally described, the vehicular head and neck safety system of the present invention includes the net, a lower ribbing forming a lower border for the net and an upper ribbing forming an upper border for the net. The lower ribbing extends from a first fastener to a second fastener and is sized to encircle the occupant's head or helmet at or just below the occupant's chin. The lower ribbing is also sized to encircle at least a portion of the headrest for securing the fasteners at an attachment point or points behind the seat. The upper ribbing extends from the first fastener to the second fastener, is positioned generally above and behind the occupant's head, and is sized to encircle at least a portion of the headrest. The net extends generally upward and rearward from a front portion of the lower ribbing, over the occupant's head or helmet, to the upper ribbing. A rear portion of the lower ribbing, the upper ribbing, and a portion of the net extending between the rear portion of the lower ribbing and the upper ribbing form a pair of straps that assist in and anchoring and manipulating the safety system.

In use, the occupant, or a member of the occupant's race team, grasps the system by the straps, pulls the net over the occupant's head, and secures the fasteners behind the headrest to the attachment point or points. The fasteners may be releasably secured at the attachment point or points so that in the case of a collision, the occupant is able to release the fasteners without assistance. Alternatively, the fasteners may be permanently secured behind the headrest at the attachment point or points, and the occupant puts on the safety system by grasping the lower ribbing and pulling the net over and down the occupant's head and face and removes safety system by grasping the lower ribbing and pulling the net up and away from the occupant's head and face.

In one embodiment, the lower ribbing, the upper ribbing, and/or the net are constructed of elastic material. During a rapid deceleration event, the the elastic safety system lessens the deceleration load imposed on the occupant's head and neck by permitting the occupant's head to begin to move forward, but still sufficiently limits the forward movement and downward rotation of the occupant's head to prevent or reduce injury.

In another embodiment, slots are provided in the headrest through which the straps are pulled when the safety system is put on the occupant.

In certain embodiments, the first fastener and the second fastener are attached to each other behind the headrest. In other embodiments, the first fastener and the second fastener are each attached, either permanently or releasably, to an anchor on the vehicle, such as the back of the seat, the headrest, or a portion of the chassis of the vehicle.

It is thus an object of the present invention to provide a head and neck safety system for restraining the forward and downward movement of an automobile occupant's head upon rapid deceleration.

A further object of the present invention is to provide a head and neck safety system, including a net, that automatically and uniformly restrains the occupant's head in a range of forward angles in order to compensate for collision angles that are left or right of head on, thereby avoiding the snap and jerk of other designs that tend to yank the occupant's head into complicity with the direction of inertia.

Another object of the present invention is to provide a head and neck safety system that will stretch and will provide a soft stop or cushion effect upon impact rather than the abrupt stop of conventional head restraints.

Yet another object of the present invention is to provide a head and neck safety system that does not interfere with the movement of the occupant's head during normal driving conditions.

A still further object of the present invention is to provide a head and neck safety device that does not interfere with the automobile's other safety equipment, such as shoulder straps.

Another object of the present invention is to provide a head and neck safety system that may be applied or taken off easily in a matter of seconds.

A further object of the present invention is to provide a head and neck safety system that is extremely light in weight, is not bulky, and is comfortable to wear.

Yet another object of the present invention is to provide a head and neck safety system that may remain in the vehicle, thereby eliminating misplacements or requiring repeated installations.

Further objects, features and advantages will become apparent upon consideration of the following detailed description of the invention when taken in conjunction with the drawing and the appended claims.

### BRIEF DESCRIPTION OF THE DRAWINGS

FIG. 1 is a side view showing a vehicular head and neck safety system in accordance with the present invention.

FIG. 2 is a perspective view showing a vehicular head and neck safety system in accordance with the present invention.

FIG. 3 is a plan view showing a vehicular head and neck safety system in accordance with the present invention.

FIG. 4 is a side view showing a vehicular head and neck safety system in accordance with the present invention during normal driving conditions.

FIG. 5 is a side view showing a vehicular head and neck safety system in accordance with the present invention during a rapid deceleration event.

### DETAILED DESCRIPTION OF THE INVENTION

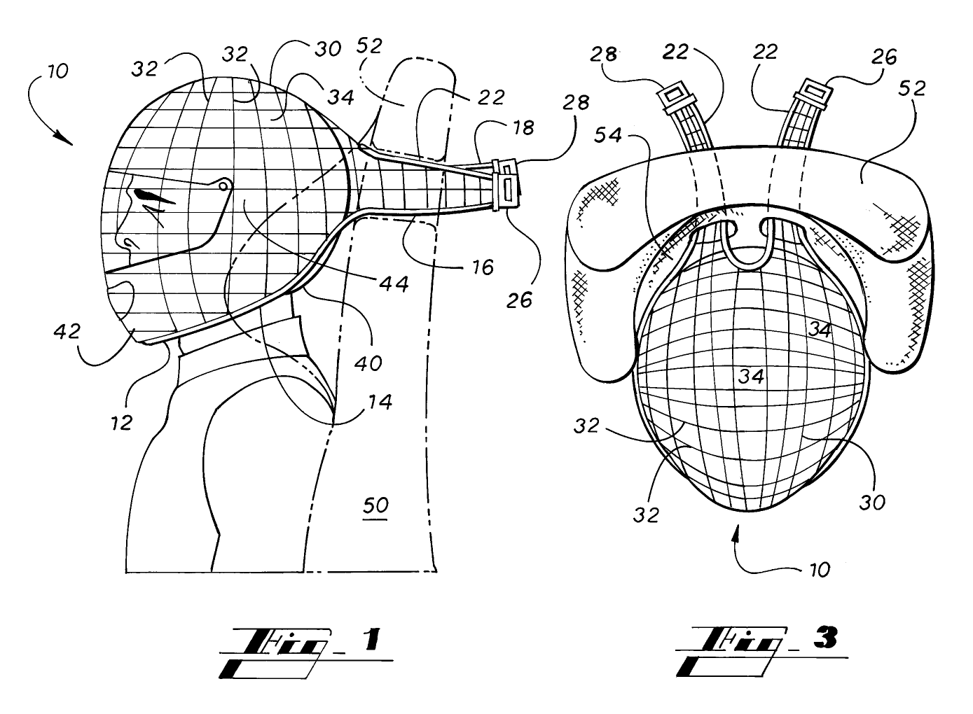

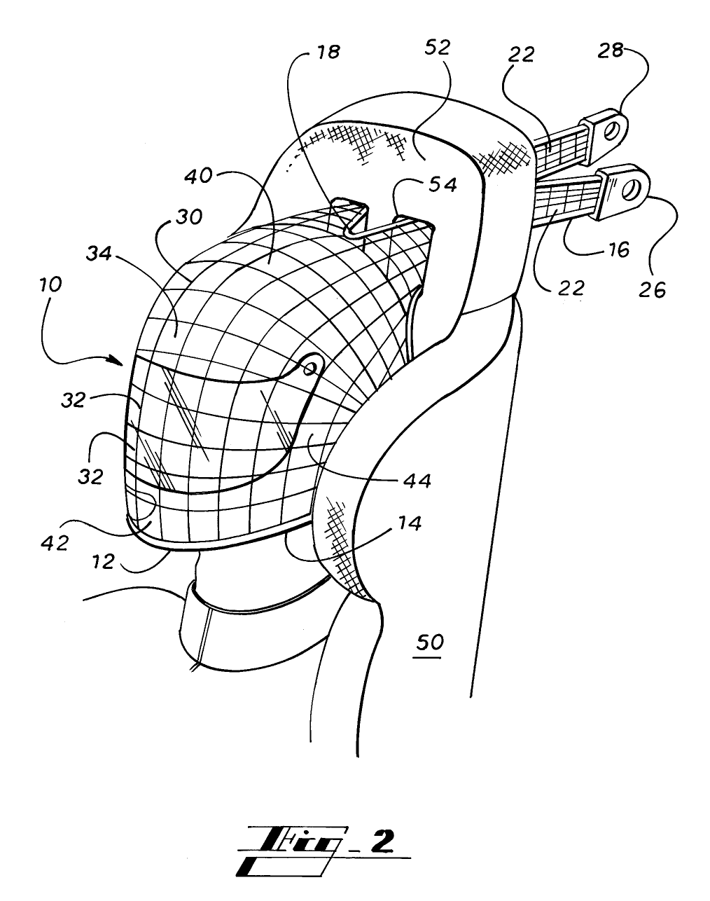

With reference to FIGS. 1-3, a vehicular head and neck safety system 10 in accordance with the present invention is shown as worn by an occupant of a vehicle, such as a driver or passenger, while seated in a seat 50 of the vehicle. The seat 50 has a headrest 52 adjacent the occupant's head 40. The occupant is shown wearing a helmet although the safety system 10 is equally applicable to an occupant without a helmet. The system 10 comprises a lower ribbing 12 extending from a first fastener 26 to a second fastener 28, an upper ribbing 18 extending from the first fastener 26 to the second fastener 28, and a net 30 extending between the lower ribbing 12 and the upper ribbing 18.

The lower ribbing 12 is sized to loosely encircle the occupant's head 40 at or below the occupant's chin 42. The lower ribbing 12 is also sized to encircle at least a portion of the headrest 52 so that the system 10 may be fastened at an attachment point or points behind the headrest 52, described in greater detail below. A front portion 14 of the lower ribbing 12 is sized to extend, on each side of the occupant's head 40, generally rearward and upward along the occupant's jaw line, from a point adjacent the occupant's chin 42, generally across the occupant's ears 44, to a point adjacent the middle of the back of the occupant's head 40. A rear portion 16 of the lower ribbing 12 is sized to extend, on each side of the occupant's head 40, generally horizontally and rearwardly from the front portion 14 to the first and second fasteners 26 and 28. The upper ribbing 18 is positioned generally above and behind the occupant's head 40 and is sized to encircle at least a portion of the headrest 52.

In various embodiments, the lower ribbing 12 or the upper ribbing 18, or both, is an elastic cord comprising one or more strands of an elastic material, such as rubber, that are bound together by a fabric covering. Due to its elastic nature, the lower ribbing 12 fits snuggly underneath the occupant's chin 42. In other embodiments, the lower ribbing 12 or the upper ribbing 18, or both, comprises a cord, ribbon, webbing, belt, or strap made of any suitable material, such as polyester or polyamide.

The net 30 is sized to extend from the front portion 14 of the lower ribbing 12 generally upward and rearward over the occupant's head 40, and from the rear portion 16 of the lower ribbing 12 generally upward, to the upper ribbing 18. The net 30 is sized to contain the occupant's head 40. The rear portion 16 of the lower ribbing 12, the upper ribbing 18, and the portion of the net 30 that extends between the rear portion 16 of the lower ribbing 12 and the upper ribbing 18 form straps 22 that assist in putting on the system 10 and in manipulating the first fastener 26 and the second fastener 28.

The net or open mesh fabric 30 is constructed of a plurality of strands 32 of material that are woven, stitched, or otherwise arranged in a mesh to form a plurality of apertures 34. The strands 32 may be connected to the lower ribbing 12 and the upper ribbing 18 by stitching, weaving, or other means. The strands 32 may comprise elastic cords constructed of one or more strands of elastic material, such as rubber, that are bound together by a fabric covering. In other embodiments, the strands 32 of the net 30 comprise cords, ribbons, webbings, belts, or straps made of any suitable material, such as polyester or polyamide. In one embodiment, each aperture 34 comprises a two (2) inch by two (2) inch square. In various other embodiments, each aperture 34 comprises a smaller or larger square, circle, polygon, or other shape of sufficient size so as not to restrict the occupant's vision. In another embodiment, one or more openings are provided at the front of the net 30, that are relatively large compared to the apertures 34, to enhance the occupant's field of vision. In yet another embodiment the net 30 may be an open mesh fabric.

The first fastener 26 and the second fastener 28 are adapted to be secured, either permanently for releasably, at an attachment point or points generally behind the headrest 52. The vertical orientation of the attachment point or points is chosen to match the height of the occupant. If the attachment point or points are too high with respect to the occupant's head, the net 30 will tend to pull up and off of the occupant's head. If the attachment point or points are too low with respect to the occupant's head, the net 30 will not adequately restrain the forward rotation of the occupant's head.

In one embodiment, slots 54 are provided in the headrest 52. The straps 22 are fed through the slots 54 and the first fastener 26 and the second fastener 28 are secured behind the headrest 52. In another embodiment, the headrest 52 comprises one or more vertical and/or horizontal bars (such as a roll bar and crossbar). The straps 22 are wrapped around opposite sides of one or more of the bars and the first fastener 26 and the second fastener 28 are secured behind the headrest 52.

In one embodiment, the first fastener 26 and the second fastener 28 engage the headrest and attached to each other so that the headrest represents the attachment point for the net 30. In another embodiment, the first fastener 26 and the second fastener 28 each attach to an anchor on the vehicle, which is the attachment point or points. The first fastener 26, the second fastener 28, or both, may comprise a carabineer, snap, clip, hook, eye, buckle, grommet, loop, or other suitable fastener. The anchor may comprise a hook, loop, bar, snap, post, or other suitable attachment point or points and may be located on the back of the seat 50, the headrest 52, or a point on the chassis of the vehicle. The attachment of the first fastener 26 and the second fastener 28 to the attachment point may be either permanent or releasable.

To use the vehicular head and neck safety system 10 of the present invention, the occupant sits in the seat 50 of the vehicle and fastens all conventional safety belts, shoulder harnesses, and other restraints. The occupant, or a member of the occupant's racing crew, first grasps the system 10 by the straps 22 and pulls the net 30 over the occupant's head 40 so that the head 40 is contained within the net 30 and the lower ribbing 12 is positioned at or just below the occupant's chin 42. Next, the straps 22 are pulled through the slots 54 in the headrest 52, or around opposite sides of one or more bars of the headrest 52. Finally, the first fastener 26 and the second fastener 28 are releasably attached either to each other or to an anchor or attachment point or points on the vehicle behind the headrest 52. The fasteners 26 and 28 may be releasably secured at the attachment point or points so that in the case of a collision, the occupant is able to release the fasteners 26 and 28 without assistance. Alternatively, the fasteners 26 and 28 may be permanently attached to the anchor, and the occupant pulls the net 30 over and down the occupant's head and face. In order to remove the net 30, the occupant pulls the net 30 up and over the occupant's head and face.

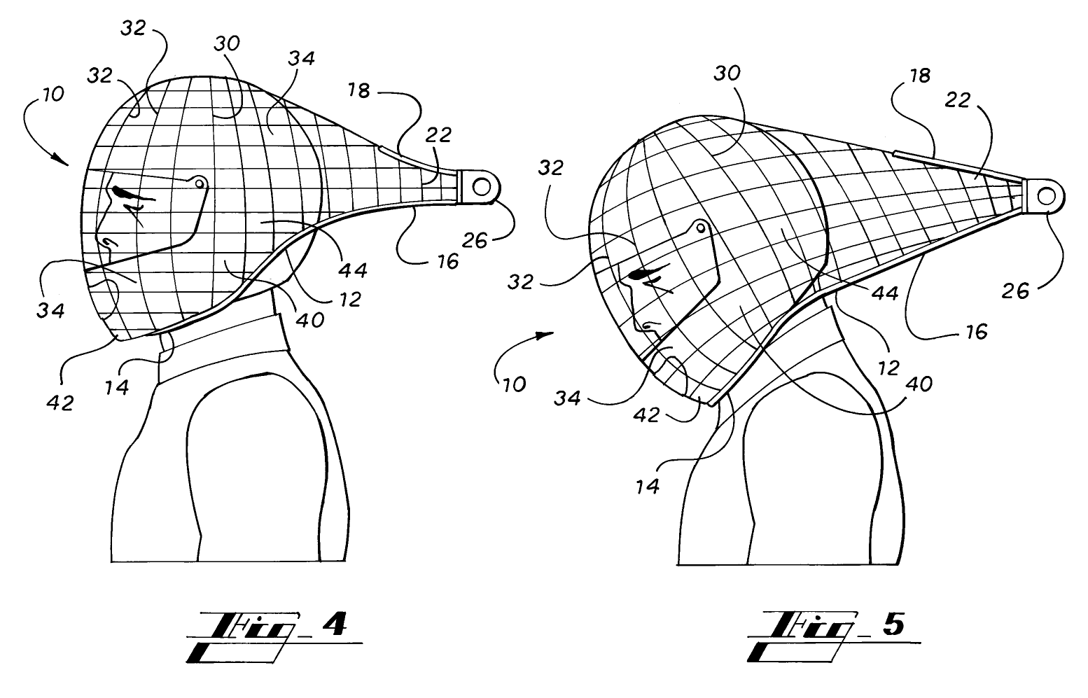

With reference to FIG. 4, during normal driving conditions, the net 30 loosely surrounds the occupant's head such that the system 10 does not restrict the occupant's ability to rotate, raise, or lower his head 40 to see the road and traffic in front of and to the sides of the vehicle. Because the strands 32 of the net 30 are generally thin and the apertures 34 of the net 30 are sufficiently large, the system 10 has no perceptible effect on the occupant's vision.

With reference to FIG. 5, during a rapid deceleration event, such as a frontal collision, the system 10 limits the forward movement and downward rotation of the occupant's head 40, thereby preventing or reducing injuries, such as a broken neck or damage to the brain. Because the safety system 10 utilizes the net 30, the safety system 10 uniformly restrains the occupant's head in a range of forward angles. When constructed of elastic materials, the system 10 allows the occupant's head 40 to begin moving forward a predetermined distance, thereby reducing the deceleration load imposed on the occupant's head 40.

Consequently, the present invention provides a simple, effective way to restrain the forward inertia of the occupant's head 40 in the event of a frontal type collision. The vehicular head and neck safety system 10 can be pulled over the occupant's head 40 or helmet and secured into place in a matter of seconds. Moreover, the vehicular head and neck safety system 10 can be removed just as easily by the occupant or by a member of the occupant's safety crew or racing team. The system 10 of the present invention is lightweight, comfortable to wear, sized to fit almost any size driver and to be used in almost any size cockpit, and, because it is applied and removed while the occupant is seated inside the vehicle, less prone to being lost after use.

Although this invention has been described in specific detail with reference to the disclosed embodiments, it will be understood that many variations and modifications may be affected within the spirit and scope of the invention as described in the following claims.

I claim:

1. A vehicular head and neck safety system for use by an occupant seated in a seat of a vehicle, wherein the seat has a headrest, to control movement of the occupant's head, the system comprising:
a. a lower ribbing extending from a first fastener to a second fastener connected to an attachment point behind the seat, wherein the lower ribbing is sized to encircle the occupant's head;
b. a upper ribbing extending from the first fastener to the second fastener; and
c. a net extending between the lower ribbing and the upper ribbing, wherein the net is sized to contain the occupant's head.

2. The vehicular head and neck safety system of claim 1, wherein the first fastener is adapted for being attached to the second fastener at a point behind the headrest.

3. The vehicular head and neck safety system of claim 1, wherein the first fastener and second fastener are adapted for being attached to an anchor on the vehicle.

4. The vehicular head and neck safety system of claim 3, wherein the anchor is on the seat of the vehicle.

5. The vehicular head and neck safety system of claim 3, wherein the anchor is on a chassis of the vehicle.

6. The vehicular head and neck safety system of claim 1, wherein the first or second fastener is selected from the group consisting of a carabineer, snap, clip, hook, eye, buckle, grommet, and loop.

7. A method for controlling movement of a vehicle occupant's head, wherein the occupant is seated in a seat having a headrest, the method comprising the steps of:
a. containing the occupant's head in a net that extends between a lower ribbing and a upper ribbing, wherein the lower ribbing extends from a first fastener to a second fastener and is sized to encircle the occupant's head and at least a portion of the headrest, and wherein the upper ribbing extends from the first fastener to the second fastener and is sized to encircle at least a portion of the headrest; and
b. securing the first and second fastener at a point behind the headrest.

8. The method of claim 7, wherein the securing the first and second fastener at a point behind the headrest includes attaching the first fastener to the second fastener.

9. The method of claim 7, wherein the securing the first and second fastener at a point behind the headrest includes attaching the first fastener and the second fastener to an anchor on the vehicle.

10. The method of claim 9, wherein the anchor is on the seat of the vehicle.

11. The method of claim 9, wherein the anchor is on a chassis of the vehicle.
